(19) United States
(12) Patent Application Publication
(10) Pub. No.: US 2017/0101981 A1
(43) Pub. Date: Apr. 13, 2017

(54) Use of Compressed Air to Generate Energy Using Wind Turbines

(71) Applicant: Huseyin Ozcan, Houston, TX (US)

(72) Inventor: Huseyin Ozcan, Houston, TX (US)

(21) Appl. No.: 14/881,155

(22) Filed: Oct. 13, 2015

(51) Int. Cl. F03D 9/00; F03D 9/10; F03D 13/20; F03D 1/06; F03D 1/04

(52) U.S. Cl. CPC F03D 9/001; F03D 1/0675; F03D 1/04; F03D 9/002; F03D 13/20; F03D 9/10

(57) ABSTRACT

The present invention is an improved arrangement for a wind turbine system wherein the power generator unit is independently installed at ground level to minimize the vertical compressive load imposed on the poles. The wind turbine system is powered by an integrated air power unit comprising an air pump driving an air motor operationally coupled to the power generator at ground level. A lighter weight air pump replacing the old system generator is operationally coupled to the wind turbine rotor blades disposed atop the pole. A pipe line supplies pressurized air from the air pump to the air motor thereby causing the power generator to rotate.

### NON-PROVISIONAL PATENT APPLICATION SPECIFICATIONS

This application claims the benefit of Provisional Application 62/123,813

### BACKGROUND OF THE INVENTION

This invention relates to wind turbines more particularly efficiently an improved method of harnessing wind power thereby converting kinetic energy to generate electrical energy.

Windmills have been known and used for centuries as power generators and typically have been used to pump water and to grind grains such as wheat and corn. Because energy from the wind is free and non-polluting, much attention has been given to improving the efficiency and lowering the cost of windmill structures. Wind power has increased exponentially since the dawn of the 21st century. The amount of power that a conventional or propeller type windmill can generate is directly proportional to the square of the diameter of the circle of rotation of the blade tips and also to the cube of the wind velocity.

A wind turbine converts kinetic energy from the wind into electrical power. Generally, wind turbines have a main rotor shaft operationally coupled to an electrical power generator that sits atop a tower that is pointed into the direction of the wind. In one embodiment the horizontal-axis wind turbines (HAWT) have the main rotor shaft arranged horizontally. Conventional HAWTs wind turbines have three blades and are oriented or pointed into the wind by computer controlled motors. These turbines typically require a supporting tower ranging from 10 to 100 meters (30 to 300 feet) in height. The blades generally rotate at a rotational speed of about 10 to 22 rpm. A gear box is commonly used to step up the speed to drive the generator. In other embodiments the vertical-axis wind turbines (or VAWTs) have the main rotor shaft arranged vertically.

As wind blows past a turbine, the blades capture the energy and rotate. This rotation triggers an internal shaft to spin, which is connected to a gearbox increasing the speed of rotation, which connects to a generator that ultimately produces electricity. Most commonly, wind turbines consist of a steel tubular tower, up to at 300 feet, which supports both a “hub” securing wind turbine blades and the “nacelle” which houses the turbine's shaft, gearbox, generator and controls. A wind turbine is equipped with wind assessment equipment and will automatically rotate into the face of the wind, and angle or “pitch” its blades to optimize energy capture.

Although HAWTs have achieved widespread usage, their efficiency is not optimized. In particular, they will not exceed the Betz limit of 59.3% efficiency in capturing the potential energy of the wind passing through it. More energy can be collected by using a variable speed turbine and a solid state power converter to interface the turbine with the generator. It is desirable to provide a lighter structure to support HAWT or VAWT wind turbines to save on manufacturing and maintenance costs.

### SUMMARY OF THE INVENTION

One of the main objectives of the present invention is to efficiently harness the wind's kinetic energy and convert it into electricity.

Another goal of the present invention is to decrease the initial capital investment required for manufacturing wind turbines

Another object of the present invention is to decrease annual maintenance costs of wind turbines.

Another object is to provide a novel wind driven power generator which is compact in size with a modular construction.

Another object of the present invention is to provide a high power-to-weight ratio at relatively low cost and without sacrifice of structural integrity.

Another object of the present invention is to provide a wind turbine system wherein the power generator is installed at ground level.

The present invention is an improved arrangement for a wind turbine system wherein the electric power generator unit is independently installed at ground level to minimize the vertical compressive load imposed on the tower poles. The wind turbine system is powered by an air power unit comprising an air compressor driving an air motor operationally coupled to the electric power generator at ground level. A lighter weight air power unit replacing the old system electric generator is operationally coupled to the wind turbine rotor blades disposed atop the pole. The pole includes wind breakers at certain intervals to reduce bending stress due to wind forces. Compressed air transferred from the air power unit to the air motor that drives the ground level electric power generator.

The pole is hollow and is constructed with a single size or multiple size smaller tapered threaded or welded casing joints which are assembled joint by joint with its lower end disposed below ground level interconnecting the electric power generator with the air power unit. As the wind turbine blades rotate compressed air is pumped through the pole to the air motor which drives the electric power generator.

The above and other objects, features and advantages of the present invention should become even more readily apparent to those skilled in the art upon a read in of the following detailed description in conjunction with the drawings wherein there is shown and described illustrative embodiments of the invention.

### BRIEF DESCRIPTION OF DRAWINGS

These and other details of the present invention will be described in connection with the accompanying drawings, which are not furnished only by way of illustration and not in limitation of the invention.

FIG. 1 frontal view of the prior art a wind turbine system.

FIG. 2 is a side perspective view of the wind turbine system of the present invention.

FIG. 3 is a side perspective view of an alternative embodiment of the wind turbine system of the present invention.

FIG. 4 is a frontal cutaway view of the compressor unit attached to HAWT disposed atop the tower.

FIG. 5 is a frontal cutaway view of the compressor unit attached to VAWT disposed atop the tower.

FIG. 6 is frontal cutaway view of the electric power generator and air motor installed at the ground level.

### DETAILED DESCRIPTION OF THE INVENTION

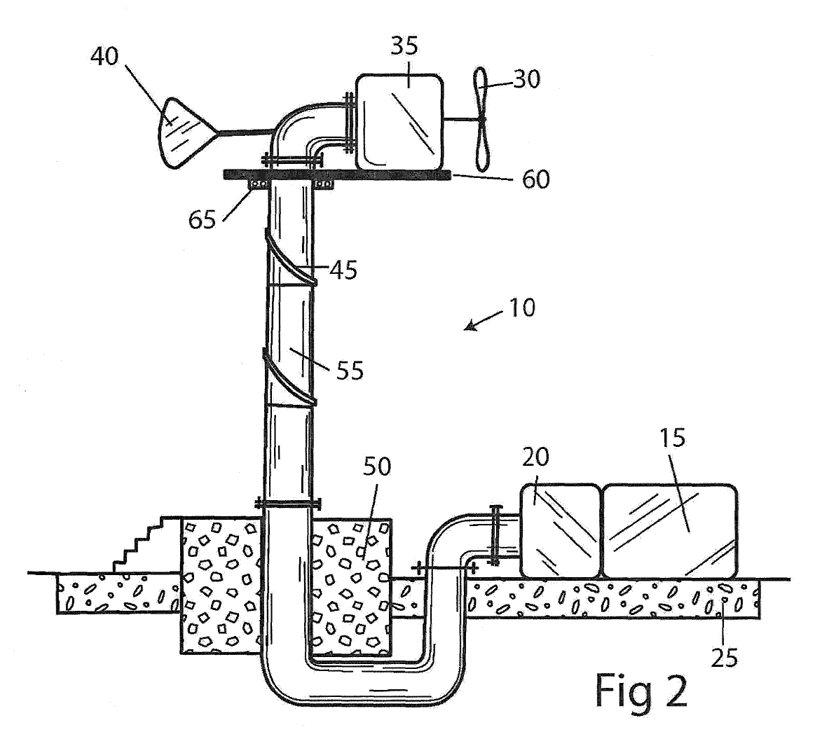

The improved wind turbine system (10) of the present invention comprises a wind assembly that drives a power generator assembly installed at ground level. As shown in FIG. 2, the wind turbine assembly comprises an air pumping unit or compressor (35) operationally coupled to an impeller or blades (30). As depicted the wind turbine assembly is supported by a flat base (60) disposed atop a tower pole situated above ground level. In the present invention, the wind stream is collected by the wind turbine assembly converted into compressed air and transported through the tower or external piping attached to the tower to the power generator assembly installed at ground level thereby converting mechanical energy into the electricity by magnetic induction. In the present invention the power generator assembly comprises an air motor (20) operationally coupled to a electric power generator (15).

Power generator assembly can be manufactured from any suitable rigid material, including plastic, steel, carbon fiber, composites and other such combination of materials. The generator is directly connected to a motor drive shaft for rotation therewith.

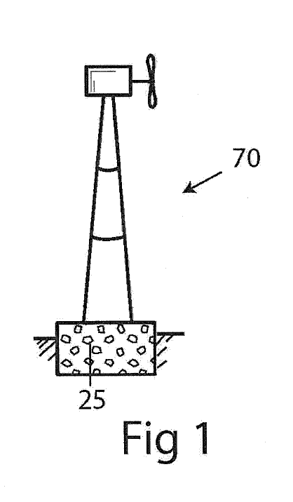

A conventional nacelle is a cover housing that contains all of the generating components of a wind turbine situated atop the tower including the power generating assembly hardware. As depicted in the prior art in FIG. 1, the tower (70) supports the entire nacelle sitting above ground level and supported below ground with base (25). In the present invention the power generator assembly is installed at ground level thereby decreasing the load atop the tower since a typical air compressor is much lighter than an electric generator.

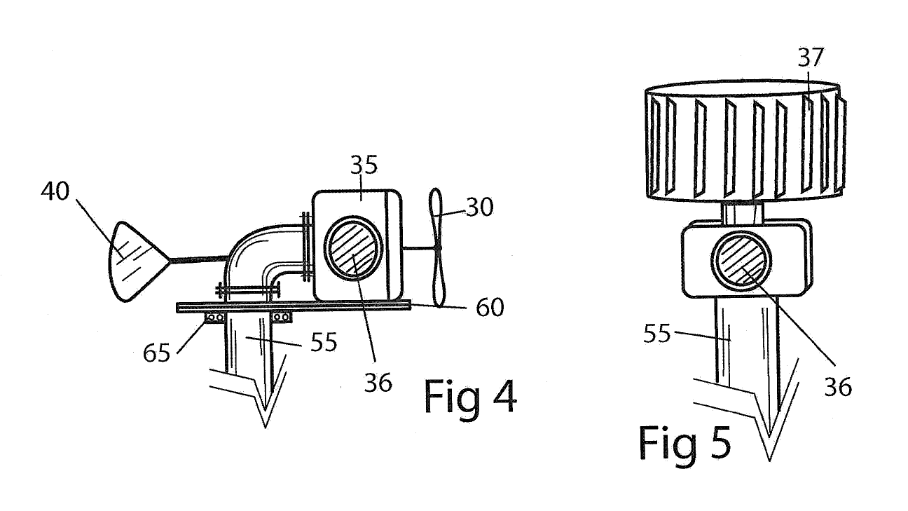

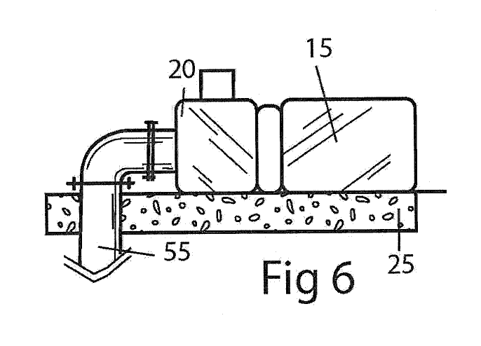

As depicted in FIGS. 4 and 5, the rotor blades can be vertically mounted (37) or horizontally mounted (30). Wind support (40) allows the platform (60) to rotate 360 degrees about rotating mechanism (65) within the direction of the wind.

Wind can occur at high or variable low velocity, which produces a wind stream that drives the wind turbine assembly to transform wind energy into the mechanical energy which is transferred to the air compressor (36). In this embodiment, blade speed control is flexible and may not be required.

As depicted in FIG. 1, a conventional wind turbine system (70) normally has a tower platform which is supported by a plurality of horizontal and diagonal supports. As illustrated in FIG. 2, the present invention has a tower that comprises a hollow elongated cylindrical pipe (55) having a top end and a lower end defining the longitudinal axis of the tower and interconnecting the wind turbine assembly (35) with the power generating assembly. Helical windbreakers (45) span the external surface of the elongated cylindrical pipe (55) thereby minimizing vibrations of the tower (55) under stress of the wind. As shown in FIG. 2, the lower end of the pipe is cemented (50) within the ground.

The top end of the tower (55) is in air fluid communication with the wind turbine assembly and the lower end of tower (55) transports compressed air into the air driven motor (20) that drives the electric power generator (15). The top end and the lower end of tower (55) has an air tight seal such that air is contained within the cylinder and prevented from seeping through transportation therein. As depicted in FIG. 2, the lower end of the pipe (55) extends horizontally below ground level to the air driven motor (20) which drives electric power generator (15). Alternatively an external piping attached to the tower can be used to transport air to electric power generator (15). The external piping can be made of steel, pvc, flexible hose or another suitable type of piping.

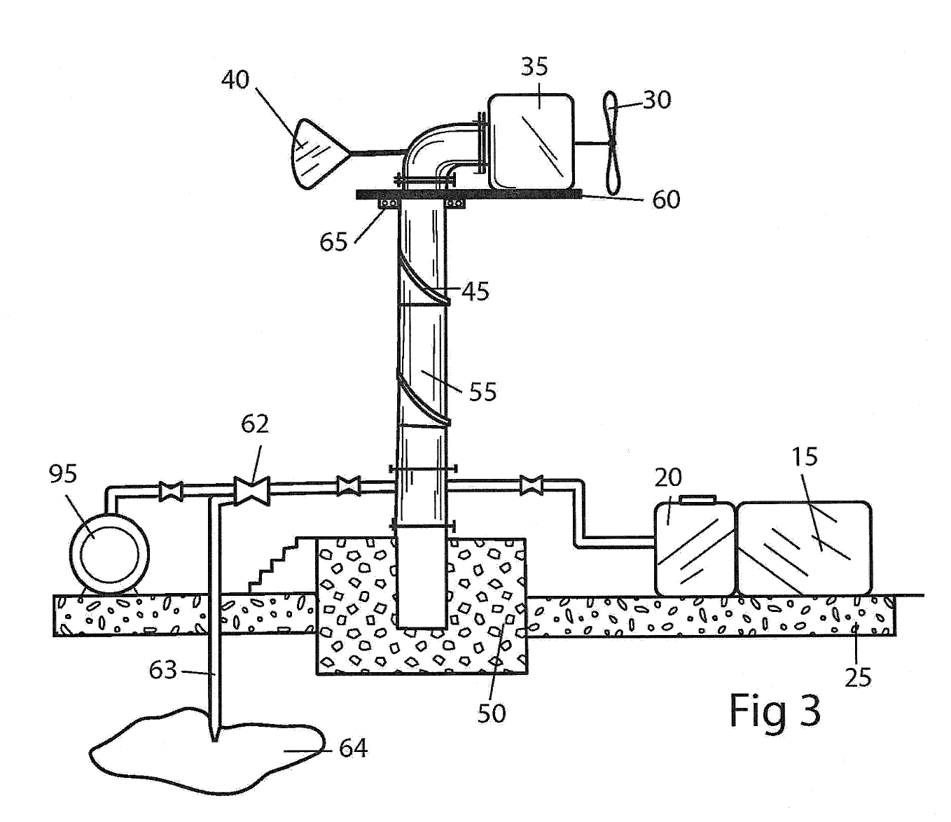

As depicted in FIG. 3, in an alternative embodiment an above ground storage reservoir (95) can be used to store excess compressed air for later use. In this embodiment, the above ground storage reservoir is a storage tank or pipeline in which access is remotely or manually controlled by valves (62). Secondary pipes extending horizontally to ground storage reservoir (95) from pipe (55). In an alternative embodiment, a below ground storage reservoir (64) can be used to store excess compressed air for later use. As shown horizontal pipe (63) extend vertically downward below ground level into storage reservoir (64) for later use when wind is low. Operationally, as the compressed air is transported linearly downward through pipe (55) valves (62) can be manually or automatically activated to divert compressed air either to above ground storage reservoir (95) or below ground storage reservoir pocket (64).

In the prior art, rotational speed of the blades and electric power generator are varied based upon the wind speed. The electric generator output direct current which is converted to alternative current. One of the main difference of this system over the prior art is that electric power generator (15) speed is constant and it is controlled by air flow rate and pressure from the tower. There is no control on the rotational speed of the blades. The electric power generator speed is controlled at ground level. At high wind velocities the system harvest the excess air into storage reservoirs (63, 64).

In this system, storing excess air underground will also help slow down subsidence of the ground level because the excess air is stored in underground porous rock.

What is claimed is:

1. A wind turbine system supported and operationally coupled a plurality of rotational blades comprising:
a power generator assembly for generating electricity installed at ground level;
a hollow cylindrical tubular tower extending above ground level defined by a top end and a lower end;
the top end and the lower end forming an air tight seal thereon wherein air is prevented from seeping therethrough;
a base disposed atop the top end of the tower to support a wind turbine assembly thereon;
the wind turbine assembly for receiving a wind stream therein and converting the wind stream into a compressed air stream;
the wind turbine assembly in fluid communication with the tower for transporting the compressed air stream therethrough; and
the lower end of the tower operationally coupled to the power generator assembly wherein the compressed air stream is received therein and transported to the power generator assembly for generating electricity therefrom.

2. The wind turbine system of claim 1 wherein the power generator assembly further comprises an air motor operationally coupled to a power generator wherein the power generator rotational speed is controlled therefrom.

3. The wind turbine system of claim 1 wherein the wind turbine assembly further comprises:
an air compressor operationally coupled to the plurality of rotational blades that is in fluid communication with the top end of the tower.

4. The wind turbine system of claim 1 wherein the plurality of rotational blades are horizontally mounted thereto.

5. The wind turbine system of claim 1 wherein the plurality of rotational blades are vertically mounted thereto.

6. The wind turbine system of claim 1 further comprises an above ground storage reservoir operationally coupled to the lower end of the tower wherein excess air from the wind stream can be diverted therefrom allowing a continuous wind stream to be provided to the power generator assembly under low wind velocities.

7. The wind turbine system of claim 1 further comprises a below ground storage reservoir operationally coupled to the lower end of the tower wherein excess air from the wind stream can be diverted therefrom allowing a continuous wind stream can be provided to the power generator assembly under low wind velocities.

8. The wind turbine system of claim 1 wherein the below ground storage reservoir is porous rock located below ground level thereby preventing ground subsistence.

9. The wind turbine system of claim 1 wherein an external pipe longitudinal extends the tower thereby allowing the wind stream to be transported therethrough.
